(19) United States
(12) Patent Application Publication
(10) Pub. No.: US 2004/0212165 A1
(43) Pub. Date: Oct. 28, 2004

(54) Skateboard truck and manufacturing method thereof

(76) Inventor: Ciro Nogueira, Sao Paulo (BR)

Correspondence Address: Gordon & Rees, 1660 Union Street, San Diego, CA, 92101-2926, US

(21) Appl. No.: 10/487,370

(22) PCT Filed: Jul. 29, 2003
(86) PCT No.: PCT/BR03/00105

(30) Foreign Application Priority Data
Aug. 8, 2002 (BR) PI0203252-0

(51) Int. Cl. B62M 1/00

(52) U.S. Cl. 280/87.042

(57) ABSTRACT

Skateboard truck and manufacturing method thereof, is characterized by being manufactured with an elastomer, forming a one-piece elastomeric body (1) comprising lateral walls (3) and a main pillar (2) with an axle (5) with screwthreaded extremities, a tubular beam (19), a baseplate (6) with holes and a lateral sliding plate (14) bonded inside of it. Such truck is lighter, more resistant to impacts and abrasion and more stable than conventional trucks allowing a good maneuverability to the skateboard The manufacturing process demands less labour than the one used for conventional trucks and is characterized by placing the metalic parts already treated inside the mould, for having a good adhesion with the elastomer, and casting, injection moulding or vulcanizing the elastomer, involving all parts, that become one single piece with the elastomer.

### BACKGROUND OF THE INVENTION

1. Field of the Invention

The invention relates to technical and functional improvements related to a skateboard truck, that could also be applied to a skate, which is a one-piece elastomeric truck with a design that makes tight turns possible having all edges rounded, being “streamlined”, lighter and having better impact and abrasion resistance, solving the problems encountered heretofore in metal and other types of one-piece plastic trucks, having a manufacturing method that is faster and cheaper than the methods utilized by the prior art trucks.

2. Description of the Prior Art

At the present time, a skateboard comprises a wood deck, to which two trucks are fixed through bolts and nuts; four wheels with its bearings are fixed to the truck's axles through nuts. The axles of the two trucks are positioned parallel to each other and to the plane of the deck.

The function of the truck is to connect the rolling parts, wheels and bearings, with the deck, allowing maneuverability to the skateboard. The steering of a skateboard is done through the leaning of the skateboarder on one side thereof, transfering pressure through his feet to the deck and truck. The higher the pressure, the smaller the steering radius, up to a predetermined limit.

According to FIG. 1, the steering of a skateboard is done through the rotational moving of the axles, caused by the skateboarder pressure on one side of the deck. The axles extremities are then approached inside the curve and moved away outside the curve, breaking off its parallelism, shortening the wheelbase on one side an lengthening it on the other.

A typical conventional truck is the one disclosed in the brazilian patent DI 5600545-8, where can be seen according to FIG. 2, that it consists of a built-up assembly of many parts, like the base plate (6), which is anchored to a deck through bolts and nuts; anchored to the baseplate there is a king pin, that has attached to it the axle hanger (4) and a pair of elastic bushings (3) intended to provide a restoring force to the truck when the skateboarder steers by shifting his weight, rotating the axle hanger (4). These bushings (3) are compressed through a lock nut (2) screwed to the kingpin. The higher the torque applied to the lock nut (2), the higher the compression force on the bushings and the higher the force necessary to steer the skateboard. In order to make sharp turns, with small turning radius, the torque applied to the lock nut must be very low, and the truck parts work very loose, causing unstability when riding at higher speeds. The bushings resistance to compression depends on their hardness and changes during its life due to wear and fatigue, changing dramatically the force necessary to steer the skateboard. Replacements and adjustments are frequently necessary. The axle (5) is anchored inside the axle hanger (4) and has its extremities screwthreaded to allow the attachment of the wheels and bearings, through small lock nuts (1). The axle (5) anchorage inside the axle hanger (4) frequently fails, since there is no chemical link between them, causing the axle (5) to slip.

The skateboard trucks must have high impact and abrasion resistance to resist “grinds”. A grind is a skateboarding maneuver and consists of sliding along on the axle hanger over a narrow surface, like the edge of a curb or the coping in a pool, with the wheels straddling the surface or not touching anything at all.

Still according to FIG. 2, the king pin and its lock nut (2) form a protuberance, which may cause hang ups during “grinds”.

The process for manufacturing a conventional truck comprises the following steps: the casting, finishing, machining, polishing and painting of the base plate (6), generally in aluminum, with the drilled holes necessary to attach it to the deck and the king pin ;the same processes for the axle hanger (4) the casting or injection moulding of the plastic bushings (3); the manufacturing by the traditional mechanical methods of the bolts, nuts and washers ;finally all the parts above must be assembled and fixed through the king pin lock nut (2). As can be observed it is very time and labour intensive, with a high cost. Another disadvantage of conventional trucks is that the bolts and nuts used to anchor it to the deck are exposed and can be damaged when “grinding”.

There are other conventional emboddiments for conventional trucks, comprising many metalic parts, including metalic coil springs in some cases.

There are also one-piece molded plastic trucks, like the one described in the U.S. Pat. No. 4,398,735, comprising a baseplate adapted to be connected to the underside of a skate, an elongate beam made from a flexible material, one end of the beam being connected to the baseplate and the beam extending at an acute angle relative thereto, an elongate axle or axle hub rigidly connected to the other end of the beam and extending perpendicular thereto, and a peg with one of its ends connected to the baseplate and the other end adjacent to the top of the axle hub. This structure firstly prevents the beam from deflecting, secondly provides a pivot point for rotation, and lastly allows one to tailor characteristics of the truck to the individual rider. However the peg is too tiny to sustain the weight of an adult, and the central point of the axle hub deviates from the central point of the mounting peg, especially when riding on road irregularities. The U.S. Pat. No. 5,143,388 solves the problems above by changing specially the peg and beam design, but keeping almost the same principle for steering. Both one-piece plastic trucks cited above are fragile, with low impact resistance Both have plastic baseplates that are fragile and may not resist the torsion caused by the steering.

All conventional trucks, the multiple metalic parts assembly trucks or the one-piece plastic trucks, do not absorb vertical shocks, with the exception of the one described in the U.S. Pat. No. 5,143,388 which has a buffer under the peg, however the size of the buffer is limited and the shock absorbing effect is very small. In all prior art trucks, the vertical shock causes the axle (5) deformation and a very uncomfortable ride, specially when landing from an “ollie”, which is a maneuver wherein the skater jumps with the skate.

Besides all the disadvantages already described regarding the U.S. Pat. Nos. 4,398,735 of 16 Aug. 1983, and 5,143,388 of 1 Sep. 1992, there is also the impossibility of using an elastomer for manufacturing it, since the elastomers are extremelly elastic and softer than the plastics referred to in those patents, like nylon. The attempt to use an elastomer in trucks according to those patents would result in skateboard trucks extremelly soft, unstable and unmaneuverable.

### SUMMARY OF THE INVENTION

The objects of the present invention are to provide a one-piece molded skate or skateboard truck that is lighter; that is more stable when riding at high speeds, still keeping its ability to steer in tight turns; that has a longer life with less fatigue; that absorbs vertical shocks better, avoiding axle deformation and making the landing more confortable for the rider; that absorbs better vibrations caused by irregularities on the riding surface; that acts like a spring when making ollies, making it easier for the skater to execute this maneuver; that eliminates the problem of axle slippage; that can be adjusted; that can grind well in concrete or metal edges, without hang ups, since it has no protuberances; that is more solid and durable, resisting the extreme stresses associated with the sport, avoiding failures very common in the state-of-the-art trucks; that protects the nuts and bolts used to anchor it to the deck; that has a simpler and cheaper manufacturing process.

### BRIEF DESCRIPTION OF THE DRAWINGS

FIG. 1 is a complete skateboard view, showing the two trucks and their rotational moving, which allows the skateboard steering;

FIG. 2 is a perspective view showing a state-of-the-art traditional truck, with multiple parts;

FIG. 3 is a rear perspective view of one of the embodiments of the present invention;

FIG. 4 is a rear perspective view, showing one of the embodiments of the present invention;

FIG. 5 is a side view of one of the embodiments of the present invention;

FIG. 6 is a front view of one of the present invention embodiments;

FIG. 7 is a rear view of one of the present invention embodiments;

FIG. 8 is a front perspective of one of the present invention embodiments;

FIG. 9 is a rear perspective of one of the present invention embodiments;

FIG. 10 is a cross-sectional view of one of the present invention embodiments, taken along line B-B of FIG. 7;

FIG. 11 is a side view of one of the present invention embodiments;

FIG. 12 is a rear view of one of the present invention embodiments.

FIG. 13 is a front view of one of the present invention embodiments;

FIG. 14 is a rear view of one of the present invention embodiments;

FIG. 15 is a front perspective of one of the present invention embodiments;

FIG. 16 is a cross-sectional view of one of the present invention embodiments, taken along line C-C of FIG. 14;

FIG. 17 is a cross section showing the profile of the tubular beam (19);

FIG. 18 is a cross section taken along the center of the axle(5) of one of the present invention embodiments;

FIG. 19 is a front view of the mould used for manufacturing the present invention truck.

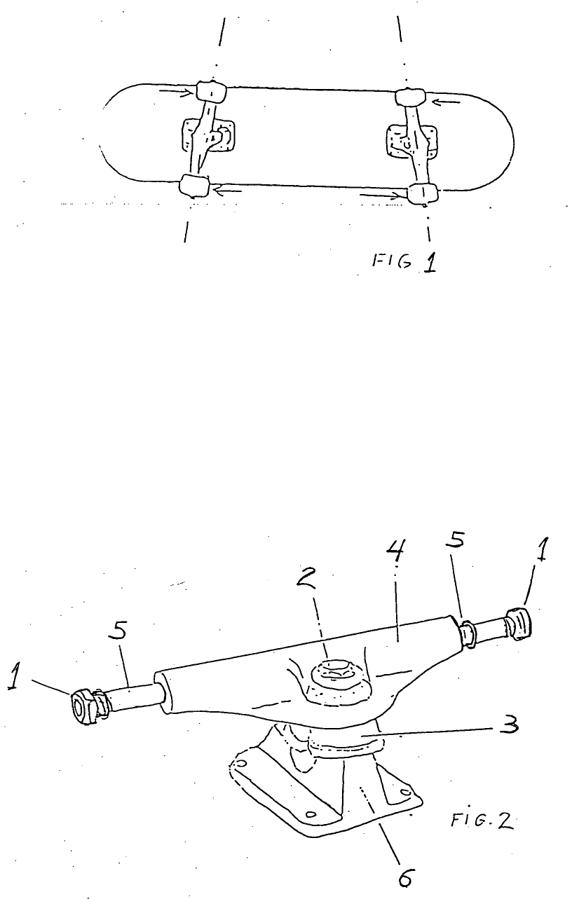

Obs.: Like parts bear like reference numerals on all drawings above, with the exception of drawing 1.

### DETAILED DESCRIPTION OF THE INVENTION

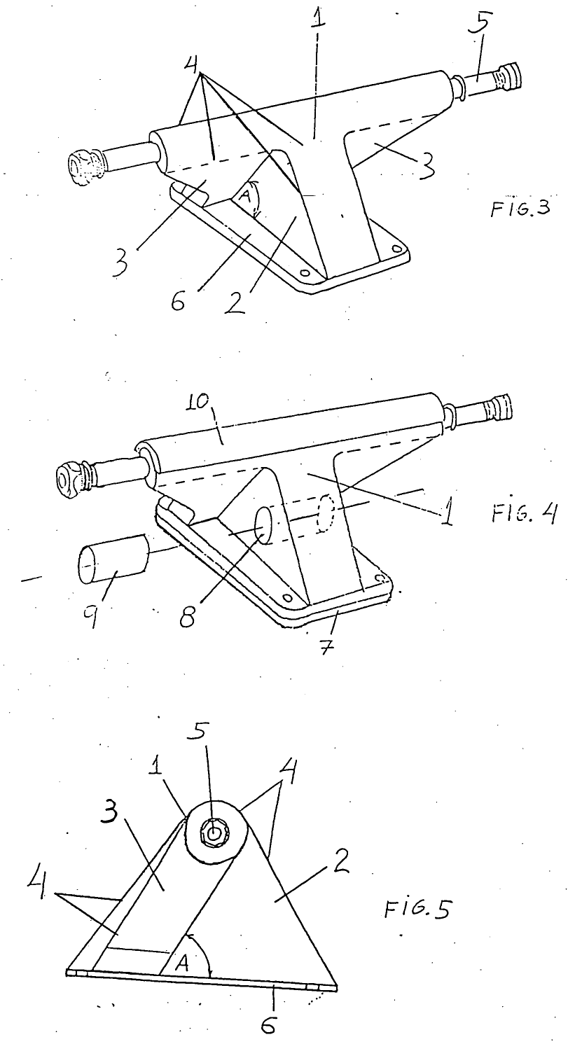

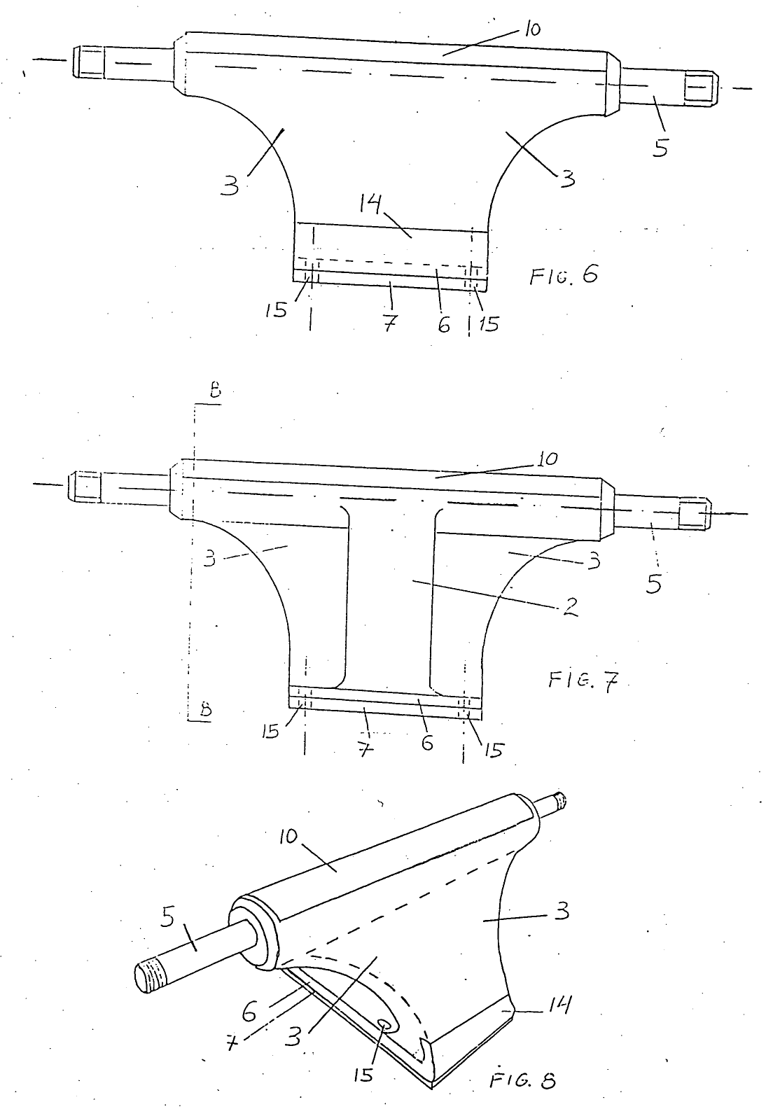

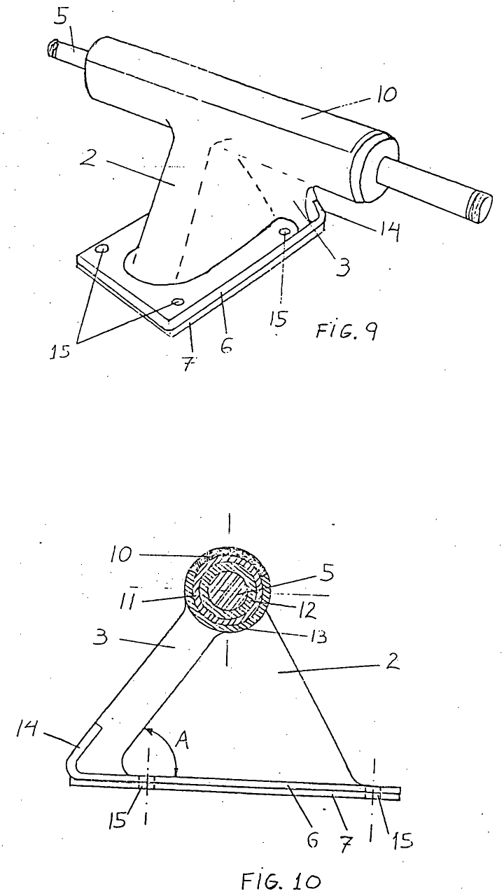

The present invention, as shown in FIG. 3 and FIG. 5, comprises a skate or skateboard truck, having a one-piece elastomeric body (1) formed by a main pillar (2) and two lateral walls (3), that due to its design and elastomeric properties, allows the axle (5) to rotate when a force is applied to one of its extremities, allowing the maneuverability of the skate or skateboard. In the present invention truck, the force necessary to steer and the minimum radius of the curve depend on the elastomer hardness and the design of the lateral walls (3) and main pillar (2). In one of the possible embodiments, the plane of the lateral walls (3) forms an angle (A) with the plane of the baseplate (6) and is perpendicular to the plane that contains the main pillar (2). The angle (A) formed between the plane of the lateral walls (3) and the plane of the baseplate (6) is directly proportional to the curve minimum radius and the force necessary to steer it. By changing this angle (A), one can obtain trucks with different minimum radii curves and different necessary steering forces The baseplate (6) may be metalic or made of a rigid plastic, with holes that allow it to be anchored to the deck, through bolts and nuts. The axle (5), is generally metalic, and is part of the one-piece elastomeric truck, having its extremities screwthreaded to allow the attachment of the wheels and bearings, through small lock nuts. The impact and abrasion resistance of the present invention truck is much better than those of the prior art trucks made of metals or rigid plastics, due to the original design and the inherent mechanycal properties of the elastomers used, having a much higher abrasion and impact resistance than aluminum and other metals.

The present invention truck, as shown in FIG. 3 and FIG. 5, has rounded edges (4), not having protuberances that could cause hang ups during “grinds”, kind of maneuvers already described above. It does not have the kingpin and lock nut present in the prior art multiple part trucks, which form a protuberance that could lock the skateboard during a grind, causing hang ups.

In another possible embodiment, as shown in FIG. 4, an elastomeric pad (7) may be incorporated to the baseplate (6), becoming part of the one-piece elastomeric body (1). Through holes in the baseplate (6), the elastomers present on both sides of it are connected, forming one continuous elastomeric body, with the baseplate (6) inside of it. In the prior art trucks, such pads are removable, not becoming part of the truck. The function of such pads is to protect the deck from a damage caused by the hard baseplate (6) during a shock.

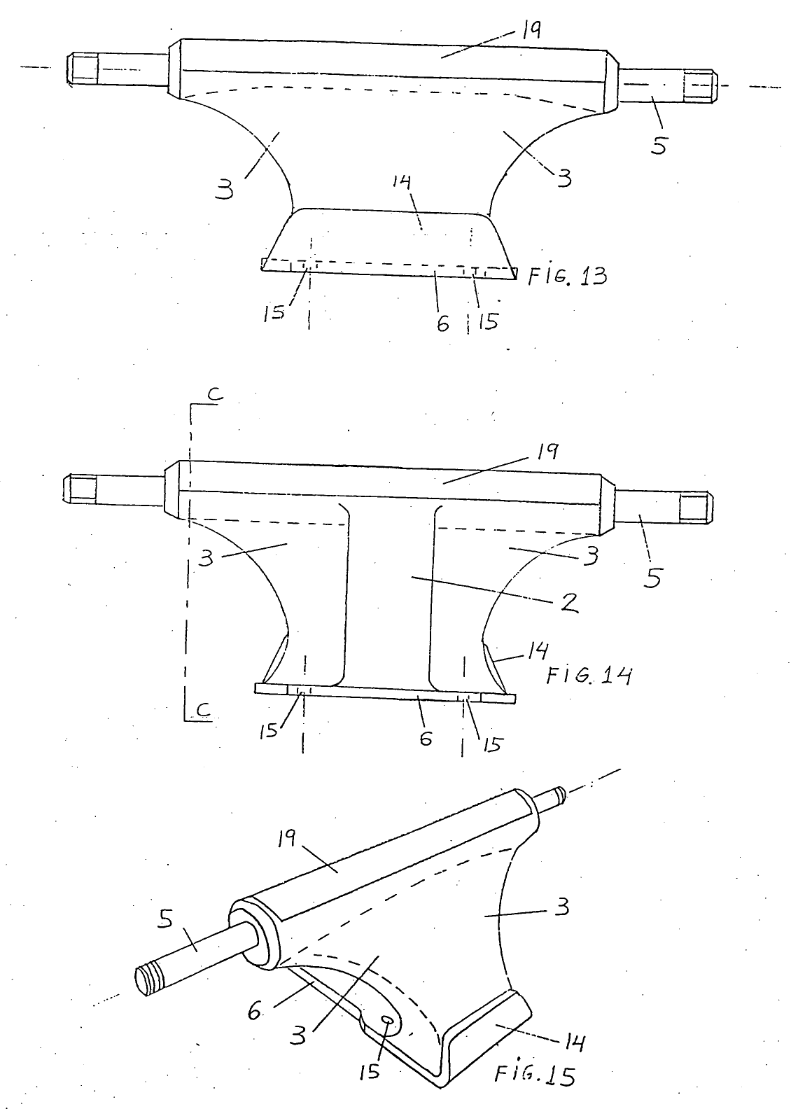

Still as shown in FIG. 4, there is another possible embodiment, where there is a hole (8) in the one-piece elastomeric body (1), where a pin (9) made of an elastomer may be inserted, allowing also the possibility of letting the hole (8) empty, in such a way that a variation in the elastomer hardness of the pin (9) affects the force necessary to rotate the axle (5) and, consequently, to steer the skateboard, allowing the truck to be adjustable. In another embodiment of such adjustment concept, as shown in FIG. 11 and FIG. 12, there is at least one central hole (16) in the baseplate (6), extending inside the main pillar (2), which becomes hollow. Inside this central hole (16) or holes, an adjustment pin (17) made of an elastomer may be inserted. The number and design of the central hole (16) and the hardness of the adjustment pin (17) influence the force necessary to rotate the axle (5) and steer the skateboard. There is also the possibility of letting the hole (16) empty. The harder the adjustment pin (17), the higher is the force necessary to steer the skateboard. Linking the central hole (16) to the external surface of the main pillar (2), there is a drain hole (18) with the function of draining the air that could be entrapped when the adjustment pin (17) is inserted. The central hole (16) and the adjustment pin (17) are represented on FIG. 11 and FIG. 12 as being cylindrical, but they may have any other configuration.

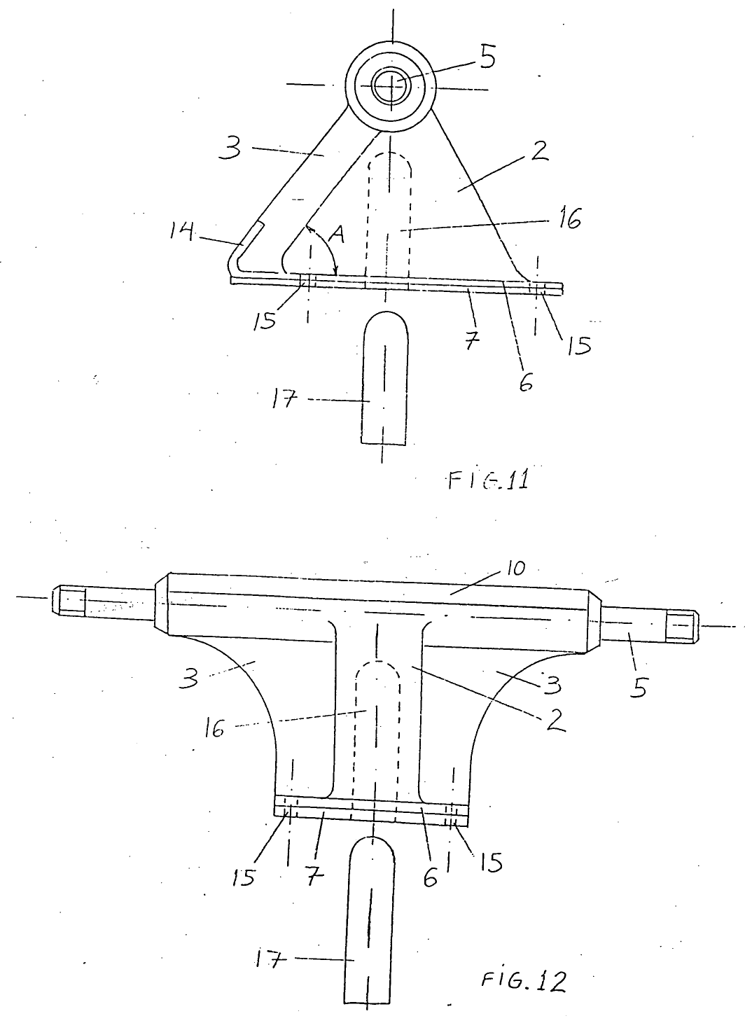

In another possible embodiment, as shown in FIG. 10, there is a tube (11) with air draining holes, placed inside the one-piece elastomeric body (1), hating concentrically inside of it, the axle (5) and an elastomer tube (12), having also a metalic plate (10) placed on the external surface of the one-piece elastomeric body (1), chemically bonded to the elastomer, in the same manner that the axle (5), the tube (11) and the baseplate (6) also are. The function of the metalic plate (10) is to facilitate the sliding of the truck during grinds on smooth surfaces. The elastomer tube (12) is part of the one piece elastomeric body (1) and is moulded at the same time as the whole elastomeric truck, as well as the cylindrical elastomeric layer (13) that covers the tube (11).

The function of the tube (11), which may be made of a metal, reinforced plastic or ceramic, is to act as part of a composite beam, composed by the axle (5), chemically bonded to the elastomer tube (12), which is also chemically bonded to the tube (11), which is also chemically bonded to the cylindrical elastomeric layer (13), being all this parts concentrical.

In another possible embodiment, the baseplate (6) has an extension in one of its extremities, called lateral sliding plate (14), that is attached externally to the base of the lateral walls (3), placed in a plane oblique with the plane that contains the baseplate (6), whose function is to facilitate the sliding of the truck in maneuvers like nose and tailslides. The lateral sliding plate (14) may be made of a metal or reinforced plastic, and may be also a separate part attached to the base of the lateral walls (3), not being a single part along with the baseplate (6).

The elastomer sliding ability in rough surfaces like concrete or asphalt is better than that of a metal, while the sliding of metals in metalic and smooth surfaces is better.

In another possible embodiment, the four attachment holes (15) of the baseplate (6),used to attach the truck to the wood deck through bolts and nuts, remain all in the same side relative to the plane of the lateral walls (3), in such a manner that the nuts used for its attachment remain under the lateral walls (3) in one of the extremeties of the baseplate (6); such configuration avoids the contact of the nuts with the riding obstacles in tails and noselides, avoiding hang ups, and also protecting the nuts and bolts from wearing and breaking due to continuous impacts, problems that happens in the state-of-the-art trucks.

Another advantage of the present invention skateboard truck is that it absorbs vertical impacts, avoiding that the axle (5) bends and buffering the impact on the skater; it also helps skaters to jump, what is called an ollie, with an effect similar to a springboard.

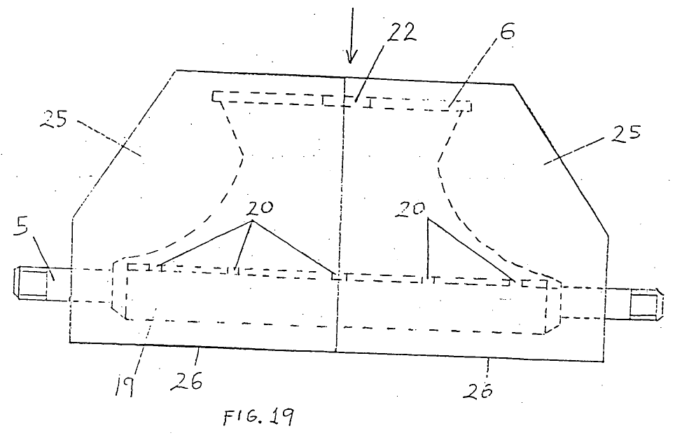

In another embodiment, according to FIG. 16, there is a tubular beam (19) with air draining holes (20) placed inside the one-piece elastomeric body (1), composed by the lateral walls (3) and main pillar (2), having concentrically inside of it an axle (5) resting on part of the internal surface of said tubular beam (19); in the space inside the tubular beam (19), between it and the axle (5), there is an internal elastomer split tube (21) which is part of the one piece elastomeric body (1) and is bonded to the tubular beam (19) and the axle (5); part of the tubular beam (19) external surface is exposed, without elastomer over it, to facilitate the sliding of the truck in grinding maneuvers. Other functions of the tubular beam (19) are to act as part of a composite beam, offering higher resistance to the flexion of the axle (5) when submitted to the riding stresses and to support the axle (5) inside the mold used in the manufacture of the present invention truck, enabling a perfect placing and centralization of both parts inside the mold, dispensing the use of centralization pegs in the mold. The tubular beam (19) may be made of a metal reinforced plastic or ceramic, and has air draining holes (20), according to FIG. 17, in order to drain the air entrapped during the casting process, injection moulding or vulcanization of the elastomer that forms the one-piece elastomeric body (1). Still according to FIG. 16, the internal elastomer split tube (21) is moulded during the process of elastomer application, being part of the one-piece elastomeric body (1), the same happening with the cylindrical elastomeric layer (13) that covers part of the external surface of the tubular beam (19). The tubular beam (19) is an embodiment that substitutes the tube (11) and the metalic plate (10), mentioned before, offering a larger wearing thickness for grinding maneuvers and facilitating the manufacturing process.

According to FIG. 17, the tubular beam (19) has air draining holes (20), having a crown profile wherein the external perimeter is formed by two concentrical archs, each one representing half the total perimeter, one with a diameter bigger than the other, being both linked by straight lines, and where the internal perimeter is also formed by two concentrical archs, with different diameters, linked by straight lines that intersect in the common center of the internal archs, which is the same of the external archs, and where the smaller diameter arch represents one third of the internal perimeter and is the region where the axle (5) rests on.

In another embodiment, according to FIG. 16, the baseplate (6), forming one single piece with the lateral sliding plate (14), may have many holes (22), that will serve for draining the air entrapped during the elastomer casting, and also for the entrance of the liquid elastomer inside the mold.

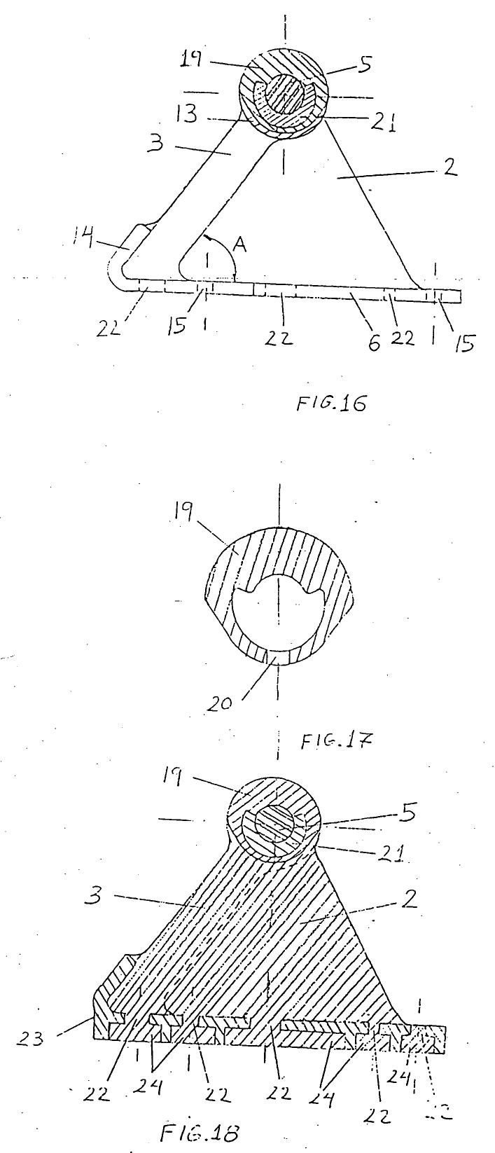

In another possible embodiment, according to FIG. 15, the baseplate (6), forming one single piece with the lateral sliding plate (14), with holes (22), has a bigger width in the region close to the attachment holes (15) located under the lateral walls (3) and a smaller width in the rest of the baseplate (6) extension, in order to increase the fatigue resistance around the attachment holes (15) under the lateral walls (3).

One of the possible ways of manufacturing the baseplate (6) with two widths along its extension, with holes (22) and with the lateral sliding plate (14) forming one single piece, is through stamping and bending a metalic sheet. It may also be obtained by casting or injection moulding of a metal.

In another possible embodiment, according to FIG. 18, a generally metalic honeycomb baseplate (23) replaces the baseplate (6), forming one single piece with the lateral sliding plate (14) or not, which also has holes (22) and cells totally filled with elastomer, forming an internal elastomer cushion (24) that becomes part of the one-piece elastomeric body (1), communicating with it through holes (22), anchoring mechanically the honeycomb baseplate (23) with the one-piece elastomeric body (1).

In another possible embodiment, according to FIG. 16, the elastomer base of the lateral walls (3) is prolonged having hexagonal holes (27) situated over the two attachment holes (15) of the baseplate (6) that are located under the lateral walls (3), in order to serve as cases for the nuts used to fix the truck to the wood deck, in such a way that the need to use a tool for srewing the nuts is dispensable.

In another possible embodiment, metalic nuts are bonded to the elastomer and baseplate (6), inside the hexagonal holes (27), over the attachment holes (15), in order to facilitate the assembling of the skateboard. It is to be understood that the invention is not to be limited by the specific illustrative embodiment, but only by the scope of the appended claims.

The manufacturing process of the truck subject of this invention is preferably done first through the surface preparation of the metalic parts used in the one-piece truck, using sandblasting, chemical treatments and adhesives in order to bond these parts to the elastomer of the one-piece elastomeric body, in such a way that after being prepared, these parts are placed inside the truck's mold, and the liquid that forms the elastomer, generally a polyurethane, is then poured, heated or not, involving the metalic parts and bonding to it, forming the one-piece elastomeric body (1); the casting may be done through a hole in the baseplate (6) or in any other part of the one-piece elastomeric body (1). The bonding of the metalic parts with the elastomer is perfect, including the axle, that does not slip during use In alternative processes the elastomer may be vulcanized or injection molded. All these processes have less steps than the process used for manufacturing and assembling state-of-the-art trucks, having a lower cost. In the elastomer casting process for the manufacturing of the truck subject of this invention, according to FIG. 19, the truck is molded through the casting of an elastomer in a mould composed of two parts (25) that fit exactly in the center of the truck, in such a way that the plane of the mold division is perpendicular to the axle (5); both parts have holes to support and guide the axle (5), avoiding also the leak of the elastomer while liquid, inside the mould; the tubular beam (19) is placed inside the mould, with the axle (5) resting on it, inside of it, with the air draining holes (20) turned up to the mould opening, through where the elastomer will enter and the air bubbles will leave; both parts of the mould have a plane base (26), that allows it to be leveled when placed over a plane surface, having also a superior plane surface with openings that allow the perfect placement of the baseplate (6) with the lateral sliding plate (14), or the honeycomb baseplate (23), depending on the desired embodiment. After the placement inside of the mould of all metalic parts that will be inserted inside the truck, previously heated, mechanically or chemically treated, and with adhesive, the elastomer is then casted through the holes (22) used for the entrance of the liquid and exit of the entrapped air, using an automatic casting machine or even manually. After a few minutes the elastomer becomes solid and the truck may be demoulded after the mould opening, and submitted to a post cure in an oven.

1-19. (canceled)

20. A skateboard truck comprising a one-piece elastomeric body (1), formed by a main pillar (2) and two lateral walls (3), having bonded inside of it a metallic axle (5) with screw threaded extremities, and a baseplate (6) with holes, that can be metallic or rigid plastic, forming a single piece with rounded edges (4), without any protuberances.

21. A skateboard truck according to claim 20, wherein the plane of the lateral walls (3) is oblique to the plane of the baseplate (6) and perpendicular to the plane of the main pillar (2).

22. A skateboard truck according to claim 20, wherein the elastomer hardness, design and dimension of the lateral walls (3) and main pillar (2), angle (A) between the plane of the lateral wails (3) and the plane of the baseplate (6), are selected in order to define the minimum steering radius and the force necessary to steer.

23. A skateboard truck according to claim 20, further comprising an elastomeric pad (7) incorporated to the baseplate (6), as part of the one-piece elastomeric body (1).

24. A skateboard truck according to claim 20, having therein a hole (8) in the one-piece elastomeric body (1), where a pin (9) made of an elastomer may be inserted, allowing also the possibility of leaving the hole (8) empty.

25. A skateboard truck according to claim 20, further comprising a metallic plate (10) incorporated on the external surface of the one-piece elastomeric body (1).

26. A skateboard truck according to claim 20, wherein the four attachment holes (15) of the baseplate (6), are located in the same side relative to the plane of the lateral walls (3), underneath them.

27. A skateboard truck according to claim 26, characterized by having a lateral sliding plate (14), made of a metal or reinforced plastic, placed in a plane oblique with the plane that contains the baseplate (6), that is attached externally to the base of the lateral walls (3).

28. A skateboard truck according to claim 26, further comprising a lateral sliding plate (14) forming a single piece along with the baseplate (6) attached to the base of the lateral walls (3) and the main pillar (2).

29. A skateboard truck according to claim 26, further comprising a tube (11) with air draining holes, made of metal, plastic or ceramic, placed and bonded inside the one-piece elastomeric body (1), having concentrically inside of it, the axle (5) and an elastomer tube (12), which is also part of the one-piece elastomeric body (1).

30. A skateboard truck according to claim 29, further comprising at least one central hole (16) of any shape in the baseplate (6), extending inside the main pillar (2), which becomes hollow, such that inside this central hole (16) or holes, an adjustment pin (17) made of an elastomer may be inserted, and linking the central hole (16) to the external surface of the main pillar (2) is a drain hole (18).

31. A skateboard truck according to claim 28, further comprising a tubular beam (19) with air draining holes (20) placed inside the one-piece elastomeric body (1), composed by the lateral walls (3) and main pillar (2), having concentrically inside of it an axle (5) resting on part of the internal surface of said tubular beam (19); having in the space inside the tubular beam (19), between it and the axle (5), an internal elastomer split tube (21) which is part of the one piece elastomeric body (1) and is bonded to the tubular beam (19) and the axle (5); and part of the tubular beam (19) external surface is exposed without elastomer over it.

32. A skateboard truck according to claim 31, further comprising a tubular beam (19) with air draining holes (20), with a crown profile wherein the external perimeter is formed by two concentrical arches, each one representing half the total perimeter, one with a diameter bigger than the other, both being linked by straight lines, and wherein the internal perimeter is also formed by two concentrical arches, with different diameters, linked by straight lines that intersect in the common center of the internal arches, which is the same of the external arches, and wherein the smaller diameter arch represents substantially one third of the internal perimeter and is the region where the axle (5) rests.

33. A skateboard truck according to claim 31, wherein the baseplate (6), forms one single piece with the lateral sliding plate (14), with holes (22), having a bigger width in the region close to the attachment holes (15) located under the lateral walls (3) and a smaller width in the rest of the baseplate (6) extension.

34. A skateboard truck according to claim 31, further comprising a generally metallic honeycomb baseplate (23) replacing the baseplate (6), which may form one single piece with the lateral sliding plate (14), which also has holes (22) and cells totally filled with elastomer, forming an internal elastomer cushion (24) that becomes part of the one-piece elastomeric body (1) communicating with it through holes (22), anchoring mechanically the honeycomb baseplate (23) with the one-piece elastomeric body (1).

35. A skateboard truck according to claim 31, wherein the elastomeric base of the lateral walls (3) is prolonged with hexagonal holes (27) situated over the two attachment holes (15) of the baseplate (6) that are located under the lateral walls (3)

36. A skateboard truck according to claim 35, further comprising metallic nuts bonded to the elastomer and baseplate (6), inside the hexagonal holes (27), over the attachment holes (15) located under the lateral walls (3).

37. A method for manufacturing a skateboard truck as defined in claim 26, said method comprising surface preparation of the metallic parts used in the one-piece truck, using sandblasting, chemical treatments and adhesives, in order to bond these parts to the elastomer of the one-piece elastomeric body, in such a way that after being prepared, these parts are placed inside the truck's mold, and the liquid that forms the elastomer, generally a polyurethane, is then poured, heated or not, injection moulded or vulcanized, involving the metallic parts and bonding to it, forming the one-piece elastomeric body (1); the casting may be done through a hole in the baseplate (6) or in any other part of the one-piece elastomeric body (1).

38. A method for manufacturing a skateboard truck as defined in claim 27, said method comprising surface preparation of the metallic parts used in the one-piece truck, using sandblasting, chemical treatments and adhesives, in order to bond these parts to the elastomer of the one-piece elastomeric body, in such a way that after being prepared, these parts are placed inside the truck's mold, and the liquid that forms the elastomer, generally a polyurethane, is then poured, heated or not, injection moulded or vulcanized, involving the metallic parts and bonding to it, forming the one-piece elastomeric body (1); the casting may be done through a hole in the baseplate (6) or in any other part of the one-piece elastomeric body (1).

39. A method for manufacturing a skateboard truck as defined in claim 28, said method comprising surface preparation of the metallic parts used in the one-piece truck, using sandblasting, chemical treatments and adhesives, in order to bond these parts to the elastomer of the one-piece elastomeric body, in such a way that after being prepared, these parts are placed inside the truck's mold, and the liquid that forms the elastomer, generally a polyurethane, is then poured, heated or not, injection moulded or vulcanized, involving the metallic parts and bonding to it, forming the one-piece elastomeric body (1); the casting may be done through a hole in the baseplate (6) or in any other part of the one-piece elastomeric body (1).

40. A method for manufacturing a skateboard truck as defined in claim 29, said method comprising surface preparation of the metallic parts used in the one-piece truck, using sandblasting, chemical treatments and adhesives, in order to bond these parts to the elastomer of the one-piece elastomeric body, in such a way that after being prepared, these parts are placed inside the truck's mold, and the liquid that forms the elastomer, generally a polyurethane, is then poured, heated or not, injection moulded or vulcanized, involving the metallic parts and bonding to it, forming the one-piece elastomeric body (1); the casting may be done through a hole in the baseplate (6) or in any other part of the one-piece elastomeric body (1).

41. A method for manufacturing a skateboard truck as defined in claim 31, said method comprising moulding the truck through the casting of an elastomer in a mold composed of two parts (25) that fit exactly in the center of the truck, in such a way that the plane of the mould division is perpendicular to the axle (5); both parts have holes to support and guide the axle (5), avoiding also the leak of the elastomer while is liquid, inside the mould; the tubular beam (19) is placed inside the mould, with the axle (5) resting on it, inside of it, with the air draining holes (20) turned up to the mould opening, through where the elastomer will enter and the air bubbles will leave; both parts of the mould have a plane base (26), that allows it to be leveled when placed over a plane surface, having also a superior plane surface with openings that allow the perfect placement of the baseplate (6) with the lateral sliding plate (14), or the honeycomb baseplate (23) depending on the desired embodiment; after the placement inside of the mould of all metallic parts that will be inserted inside the truck, previously heated, mechanically or chemically treated, and with adhesive, the elastomer is then cast through the holes (22) used for the entrance of the liquid and exit of the entrapped air, using an automatic casting machine or even manually; until the elastomer becomes solid, the truck then being demoulded after the mould opening, and submitted to a post cure in an oven.

42. A method for manufacturing a skateboard truck as defined in claim 32, said method comprising moulding the truck through the casting of an elastomer in a mold composed of two parts (25) that fit exactly in the center of the truck, in such a way that the plane of the mould division is perpendicular to the axle (5); both parts have holes to support and guide the axle (5), avoiding also the leak of the elastomer while is liquid, inside the mould ; the tubular beam (19) is placed inside the mould, with the axle (5) resting on it, inside of it, with the air draining holes (20) turned up to the mould opening, through where the elastomer will enter and the air bubbles will leave; both parts of the mould have a plane base (26), that allows it to be leveled when placed over a plane surface, having also a superior plane surface with openings that allow the perfect placement of the baseplate (6) with the lateral sliding plate (14), or the honeycomb baseplate (23) depending on the desired embodiment; after the placement inside of the mould of all metallic parts that will be inserted inside the truck, previously heated, mechanically or chemically treated, and with adhesive, the elastomer is then cast through the holes (22) used for the entrance of the liquid and exit of the entrapped air, using an automatic casting machine or even manually; until the elastomer becomes solid, the truck then being demoulded after the mould opening, and submitted to a post cure in an oven.

43. A method for manufacturing a skateboard truck as defined in claim 33, said method comprising moulding the truck through the casting of an elastomer in a mold composed of two parts (25) that fit exactly in the center of the truck, in such a way that the plane of the mould division is perpendicular to the axle (5); both parts have holes to support and guide the axle (5), avoiding also the leak of the elastomer while is liquid, inside the mould ; the tubular beam (19) is placed inside the mould, with the axle (5) resting on it, inside of it, with the air draining holes (20) turned up to the mould opening, through where the elastomer will enter and the air bubbles will leave; both parts of the mould have a plane base (26), that allows it to be leveled when placed over a plane surface, having also a superior plane surface with openings that allow the perfect placement of the baseplate (6) with the lateral sliding plate (14), or the honeycomb baseplate (23) depending on the desired embodiment; after the placement inside of the mould of all metallic parts that will be inserted inside the truck, previously heated, mechanically or chemically treated, and with adhesive, the elastomer is then cast through the holes (22) used for the entrance of the liquid and exit of the entrapped air, using an automatic casting machine or even manually; until the elastomer becomes solid, the truck then being demoulded after the mould opening, and submitted to a post cure in an oven.

44. A method for manufacturing a skateboard truck as defined in claim 34, said method comprising moulding the truck through the casting of an elastomer in a mold composed of two parts (25) that fit exactly in the center of the truck, in such a way that the plane of the mould division is perpendicular to the axle (5); both parts have holes to support and guide the axle (5), avoiding also the leak of the elastomer while is liquid, inside the mould; the tubular beam (19) is placed inside the mould, with the axle (5) resting on it, inside of it, with the air draining holes (20) turned up to the mould opening, through where the elastomer will enter and the air bubbles will leave; both parts of the mould have a plane base (26), that allows it to be leveled when placed over a plane surface, having also a superior plane surface with openings that allow the perfect placement of the baseplate (6) with the lateral sliding plate (14), or the honeycomb baseplate (23) depending on the desired embodiment; after the placement inside of the mould of all metallic parts that will be inserted inside the truck, previously heated, mechanically or chemically treated, and with adhesive, the elastomer is then cast through the holes (22) used for the entrance of the liquid and exit of the entrapped air, using an automatic casting machine or even manually; until the elastomer becomes solid, the truck then being demoulded after the mould opening, and submitted to a post cure in an oven.
